(19) United States
(12) Patent Application Publication
(10) Pub. No.: US 2025/0119297 A1
(43) Pub. Date: Apr. 10, 2025

(54) Device for Identifying an Owner, Server, User Terminal, Vehicle, and Method for Identification of an Owner

(71) Applicant: Bayerische Motoren Werke Aktiengesellschaft, Muenchen (DE)

(72) Inventors: Sven Hofmann, Muenchen (DE); Thorsten Knott, Tuntenhausen (DE); Christoph Ruester, Muenchen (DE)

(21) Appl. No.: 18/835,962

(22) PCT Filed: Nov. 30, 2022
(86) PCT No.: PCT/EP2022/083783

§ 371 Date: Aug. 5, 2024

(30) Foreign Application Priority Data
Feb. 22, 2022 (DE) 10 2022 104 090.9

(51) Int. Cl. H04L 9/32; G06F 21/35; H04W 4/40

(52) U.S. Cl. CPC H04L 9/3247; G06F 21/35; H04W 4/40; H04L 2209/84

(57) ABSTRACT

A device for identification of an owner includes an interface and a control module. The interface is configured to communicate with a user terminal. The control module is configured to control the interface. The control module is further configured to receive information about an intended identification of the user terminal. The control module is also configured to generate signed information based on the information about an intended identification, wherein the signed information can be used for identification of the owner, and send the signed information to the user terminal.

The present application is the U.S. national phase of PCT Application PCT/EP2022/083783 filed on Nov. 30, 2022, which claims priority of German patent application no. 10 2022 104 090.9 filed on Feb. 22, 2022, the entire contents of which are incorporated herein by reference.

### TECHNICAL FIELD

This disclosures relates generally to identification of an owner and in particular, but not exclusively, to identification of an owner of a vehicle.

### TECHNICAL BACKGROUND

In order for a user, such as an owner, to be able to perform an owner pairing with a device, such as a vehicle, it must be ensured that this user is the actual owner of the vehicle. For example, two physical keys can be used for this. These two physical keys can be arranged in the vehicle, for example, to prove ownership of the vehicle. This is based on the assumption that only the owner of a vehicle has access to the two physical keys. Another user, who may be in temporary possession of a physical key, may not be able to perform an owner pairing with the vehicle because they do not have the second key, for example at a valet service, a gas station, etc. Alternatively, a verification of an owner can also be carried out at a dealer of a vehicle, for example with the vehicle documents. Placing a plurality of keys in a vehicle to prove ownership or visiting a dealer can detract from or reduce a user experience. There is therefore a need to provide an alternative device for identification of an owner.

### SUMMARY

The above-described need, as well as others, are addressed by at least some embodiments disclosed and claimed herein.

Exemplary embodiments concern a device for identification of an owner, containing an interface designed to communicate with a user terminal and a control module designed to control the interface. In addition, the control module is designed to receive information about an intended identification from the user terminal and to generate signed information based on the information about an intended identification. The signed information can be used for identification of the owner. Furthermore, the control module is suitable for sending the signed information to the user terminal. This allows the user terminal to receive signed information from the device that enables the user terminal, for example a user of the user terminal, to prove ownership. As a result, a user may only need a user terminal, such as their smartphone, and the device to identify themself as the owner.

In this exemplary embodiment, communication between the device and the user terminal can be carried out by means of near-field communication (NFC). This makes it possible for receiving the signed information to be carried out in an improved manner, for example. In particular, misuse by third parties can be minimized due to the near-field communication.

In one or more embodiments, the signed information can include time information about a generation of the signed information. This can ensure that a former owner of the device can no longer be in possession of valid signed information. In particular, the signed information provided by a former owner of the device can be invalid, for example because the time information enables it to be concluded that it was generated too long ago.

Exemplary embodiments also concern a server for identification of an owner, containing an interface designed to communicate with a user terminal and a control module designed to control the interface. Furthermore, the control module is designed to send information about an intended identification to the user terminal and to receive signed information based on the sent information from the user terminal. The signed information can be used for identification of the owner. Furthermore, the control module is designed to verify the validity of the signed information and, if the signed information is valid, to send information for identification of the owner to the user terminal. This enables a server to monitor an identification as a central instance, such as a backend. For example, the server may have information about the identity of the device, so that the server can perform a validity check.

In at least one exemplary embodiment, the information about an intended identification may include a period of validity of the intended identification. This can ensure that a former owner of the device can no longer be in possession of signed information. In particular, the signed information provided by a former owner of the device may be invalid, for example because the validity period of the intended identification has been exceeded.

In one or more exemplary embodiments, the control module may also be designed to receive a request for an intended identification from a user terminal. This enables a user of a user terminal to actively start an identification as owner by the server.

The control module may also be designed to generate a digital signature based on the signed information. The digital signature can enable unique identification of the owner. Furthermore, the control module can be designed to send the digital signature to the user terminal. This allows, for example, information in the form of the digital signature to be generated that identifies the user of the user terminal as the owner of the vehicle, for example a digital vehicle registration document.

Exemplary embodiments also concern a user terminal for identification of an owner containing an interface designed to communicate with a server and a hardware token and a control unit designed to control the interface. Furthermore, the control module is designed to send a request for an intended identification to the server and to receive information about an intended identification from the server. In addition, the control module is designed to send the information about the intended identification to the hardware token and to receive signed information based on the information about the intended identification from the hardware token. The signed information can be used for identification of the owner. Furthermore, the control module is designed to send the signed information to the server and receive information for identification of the owner from the server. This means that a user of the user terminal, if they are in physical possession of the device, can perform an owner pairing with their user terminal alone.

The control module can also be designed to perform a verification of the signed information based on the intended identification. This makes it possible to check whether a device matches a request for an identification.

In some embodiments, the control module may also be designed to receive a digital signature from the server. The digital signature can enable a unique identification of the owner. In particular, this allows a user of the user terminal to prove ownership, for example the digital signature can be a digital vehicle registration document.

The control module may also be designed to perform a pairing, in particular an owner pairing, with a vehicle based on the information for identification of the owner. This makes it easier for a user of the user terminal to carry out an (owner) pairing with their vehicle.

Exemplary embodiments also create a vehicle with a device as described herein.

Exemplary embodiments also concern a method (for a device) for identification of an owner, including receiving information about an intended identification from a user terminal, and generating signed information based on the information about an intended identification. The signed information can be used for identification of the owner. The method also includes sending the signed information to the user terminal.

Exemplary embodiments also concern a method for a server, including sending information about an intended identification to a user terminal and receiving signed information based on the sent information from the user terminal. The signed information can be used for identification of the owner. The method also includes verifying the validity of the signed information and sending information for identification of the owner to the user terminal if the signed information is valid.

Exemplary embodiments also concern a method for a user terminal including sending a request for an intended identification to a server and receiving information about an intended identification from the server. The method also includes sending the information about the intended identification to a hardware token and receiving signed information based on the information about an intended identification from the hardware token. The signed information can be used for identification of the owner. The method also includes sending the signed information to the server and receiving information for identification of the owner from the server.

Exemplary embodiments also create a computer program for performing one of the methods described herein when the computer program is running on a computer, a processor, or a programmable hardware component.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a block diagram of an exemplary embodiment of a device;

FIG. 2 shows a block diagram of an exemplary embodiment of a server;

FIG. 3 shows a block diagram of an exemplary embodiment of a user terminal;

FIG. 4 shows a flowchart of an example of a method;

FIG. 5 shows a schematic representation of an example of a method;

FIG. 6 shows a schematic representation of another example of a method; and

FIG. 7 shows a schematic representation of another example of a method.

### DETAILED DESCRIPTION

Various exemplary embodiments are now described in more detail with reference to the accompanying drawings, in which some exemplary embodiments are shown. In the figures, the thickness dimensions of lines, layers and/or regions may be exaggerated for the sake of clarity.

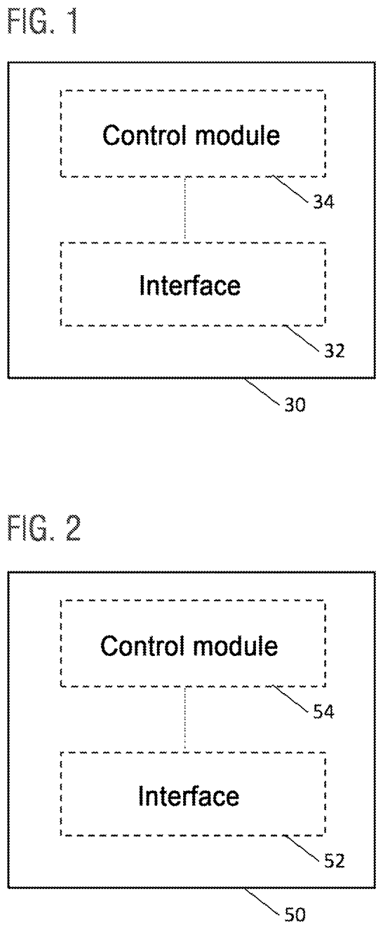

FIG. 1 shows a block diagram of an exemplary embodiment of a device 30. The device 30 for identification of an owner contains an interface 32 designed to communicate with a user terminal and a control unit 34 designed to control the interface 32. Furthermore, the control module 34 is designed to receive information about an intended identification from the user terminal and to generate signed information based on the information about an intended identification. The signed information can be used for identification of the owner. Furthermore, the control module 34 is suitable for sending the signed information to the user terminal. This means that the device 30 can be used to prove ownership.

For example, the device 30 may contain information needed to identify ownership. For example, information that enables unique identification may be stored on a memory medium of the device 30. For example, the device 30 may be associated with a vehicle. The device 30 can then contain information that enables an owner of the device 30 to establish ownership of an associated device, for example a vehicle. In particular, the device 30 can act as proof of ownership for the vehicle. This enables a user of a user terminal to prove ownership of a vehicle using the device 30 alone, such as a hardware token.

In particular, an owner of the device 30 can prove ownership of a vehicle without having to be physically with a device, such as the vehicle, that is associated with the device 30. This can improve a user experience. Furthermore, the device 30 alone can be used for unique identification, whereby costs, for example for a plurality of vehicle keys, can be reduced.

For example, a vehicle buyer can be provided with the device 30, for example a hardware token 30, which the vehicle buyer can use to digitally identify themself as a vehicle owner. In particular, the hardware token can be more cost-effective than a plurality of vehicle keys. Furthermore, the hardware token can be uniquely assigned to a vehicle. Furthermore, the hardware token can communicate with a smart device (for example via NFC). In particular, this can simplify the exchange of information between the user terminal and the hardware token.

Furthermore, the hardware token can create cryptographic signatures. In particular, this can improve the security of signed information. For example, the signed information can be encrypted using cryptography, for example asymmetric cryptography. For example, a vehicle buyer can scan the hardware token using their user terminal. In particular, this allows identification to another instance, such as a server, which allows the vehicle buyer to prove that they are the owner. In particular, verification of vehicle documents by a dealer, which can be costly and not customer-friendly, can also be omitted.

The information about an intended identification may be received, for example, from the user terminal of an owner that wishes to identify themself as the owner of a device belonging to the device 30, such as a vehicle. For example, the user can send a request, for example in the form of a challenge, to the device 30 by means of their user terminal. The request may include the intended identification, for example after a vehicle purchase and taking possession of the device 30.

The signed information may include, in particular, information which includes an unambiguous assignment of the device belonging to the device 30. For example, the device 30 may be associated with a vehicle. The device 30 can then, for example, generate signed information, for example by means of cryptography, which is uniquely associated with the vehicle. This enables another instance, such as a server, to carry out an identification.

In an exemplary embodiment, communication between the device 30 and the user terminal can take place by means of near-field communication. This can make it more difficult, for example, for a third party to read out the device 30 because they have to get very close to the device 30. In particular, due to near-field communication, only a user who is in direct physical possession of the devices 30 can communicate with them by means of a user terminal.

In an exemplary embodiment, the device 30 can be contained by a vehicle or integrated into a vehicle. For example, any user who has access to the vehicle can also have access to the device 30. This enables a user of the vehicle, for example, to authenticate themself to a server using the device 30. For example, the server may assume that a user who has access to the hardware token is also entitled to have the vehicle, for example without being the owner. For example, a rental vehicle may be connected to a fleet backend server. A user within the rental vehicle can then communicate with the device 30 via their user terminal, which can allow them to start an engine, for example. In particular, the fleet backend server may receive information about an upcoming use. In particular, communication with the device 30 by means of the user terminal can therefore only lead to authentication as a user if the fleet backend server has previously received information about this.

In an exemplary embodiment, the signed information can include time information about a generation of the signed information. As a result, in particular a validity period for the signed information can be generated. For example, after a vehicle has been sold, a former owner of the device can no longer use previously generated signed information. In particular, this can improve the degree to which the information about an identification of an owner is up to date.

As shown in FIG. 1, the one or more interfaces 32 are coupled to the respective control module 34 of the device 30. In examples, the device 34 can be implemented by one or more processing units, one or more processing devices, any means of processing, such as a processor, a computer or a programmable hardware component that can be operated with appropriately adapted software. Likewise, the described functions of the control module 34 can also be implemented in software, which is then executed on one or more programmable hardware components. Such hardware components may be a multi-purpose processor, a digital signal processor (DSP), a microcontroller, etc. The control module 34 may be able to control the one or more interfaces 32 so that any data transmission carried out through the one or more interfaces 32 and/or any interaction in which the one or more interfaces 32 may be involved can be controlled by the control module 34.

In an embodiment, the device 30 may contain a memory and at least one control module 34 which is functionally coupled to the memory and configured in such a way that it will carry out the method described below.

In examples, the one or more interfaces 32 can correspond to any means for obtaining, receiving, transmitting, or providing analog or digital signals or information, for example any port, contact, pin, register, input port, output port, conductor, track, etc., that allows the provision or receipt of a signal or information. The one or more interfaces 32 can be wireless or wired and can be configured to communicate with other internal or external components, for example to send or receive signals or information.

In particular, the device 30 can be a hardware token, a processor, an application-specific integrated circuit (ASIC), an integrated circuit (IC) or a system-on-a-chip system (SoC), etc.

Further details and aspects are mentioned in connection with the exemplary embodiments described below. The exemplary embodiment shown in FIG. 1 may include one or more optional additional features corresponding to one or more aspects that are mentioned in connection with the proposed concept or one or more exemplary embodiments described below (for example in FIGS. 2-7).

FIG. 2 shows a block diagram of an exemplary embodiment of a server 50. The server 50 for identification of an owner contains an interface 52 designed to communicate with a user terminal and a control module 54 designed to control the interface. In addition, the control module 54 is designed to send information about an intended identification to the user terminal and to receive signed information from the user terminal based on the information sent. The signed information can be used for identification of the owner. Furthermore, the control module 54 is designed to verify the validity of the signed information and, if the signed information is valid, to send information for identification of the owner to the user terminal. The server 50 can therefore be designed in particular to verify an identification of the owner. For example, the server 50 may contain information about the device from FIG. 1 so that the server 50 can verify the signed information. The signed information may have been generated, for example, by a device as described above, in particular in connection with FIG. 1. For example, the information about the intended identification can be the same information as described with reference to FIG. 1. In particular, the server 50 may interact with the user terminal of the owner who wishes to carry out identification and the device shown in FIG. 1 in order to enable identification of the owner. For example, the server 50 can be a control instance that can verify the validity of the signed information, for example based on information about an association of the device from FIG. 1 and an associated device. This information may be stored, for example, on a memory medium of the server 50 and/or retrieved by the server from a communicatively coupled memory medium, for example a cloud.

The information for identification of the owner may allow the user of the user terminal to perform an owner pairing with the associated device, such as a vehicle.

In an exemplary embodiment, the information about an intended identification may include a period of validity of the intended identification. For example, the server 50 can restrict the validity of the intended identification, so that the validity of generated signed information can also be restricted. In particular, this can prevent misuse of outdated generated signed information.

In an exemplary embodiment, the control module 54 may also be designed to receive a request for an intended identification from a user terminal. For example, a user of the user terminal, for example a vehicle buyer, can request an identification from the server 50 and only then receive information about an intended identification, such as a challenge. The information about the intended identification may be required in particular so that the device from FIG. 1 can generate signed information. In particular, this allows the entire process of identifying the owner to be controlled by the server 50. In particular, not every user terminal can send information about an intended identification to the device in FIG. 1, but only when this has been received from the server 50. This makes it possible for control to be carried out by the server 50. For example, a vehicle salesperson can notify the server 50 of a vehicle sale so that it can generate information about an intended information in the event of a request from a user terminal.

In an exemplary embodiment, the control module may also be designed to generate a digital signature based on the signed information. In particular, the digital signature can enable unique identification of the owner. For example, the digital signature can be a digital document that identifies the owner of this signature as the owner of the associated device, such as the vehicle. For example, the digital signature can be a digital vehicle registration document.

As shown in FIG. 2, the one or more interfaces 52 are connected to the respective control module 54 of the server 50. In examples, the device 54 can be implemented by one or more processing units, one or more processing devices, any means of processing, for example a processor, a computer or a programmable hardware component that can be operated with appropriately adapted software. Likewise, the described functions of the control module 54 can also be implemented in software, which is then executed on one or more programmable hardware components. Such hardware components may include a multi-purpose processor, a digital signal processor (DSP), a microcontroller, etc. The control module 54 may be able to control the one or more interfaces 52 so that any data transmission carried out through the one or more interfaces 52 and/or any interaction in which the one or more interfaces 52 may be involved, can be controlled by the control module 54.

In an embodiment, the server 50 may contain a memory and at least one control module 54 that is functionally coupled to the memory and configured to carry out the method described below.

In examples, the one or more interfaces 52 may correspond to any means of obtaining, receiving, transmitting, or providing analog or digital signals or information, for example any port, contact, pin, register, input port, output port, conductor, track, etc., that allows the provision or receipt of a signal or information. The one or more interfaces 52 may be wireless or wired and can be configured to communicate with other internal or external components, for example can send or receive signals or information.

For example, the server 50 can contain a computer, a processor, a control unit, a (field) programmable logic array ((F)PLA), a (field) programmable gate array ((F)PGA), a graphics processing unit (GPU), an application-specific integrated circuit (ASIC), an integrated circuit (IC) or a system-on-a-chip (SoC) system.

The server 50 can generally be a device that is capable of communicating wirelessly. The server 50 can be a device in the sense of the respective communication standards used for mobile communication.

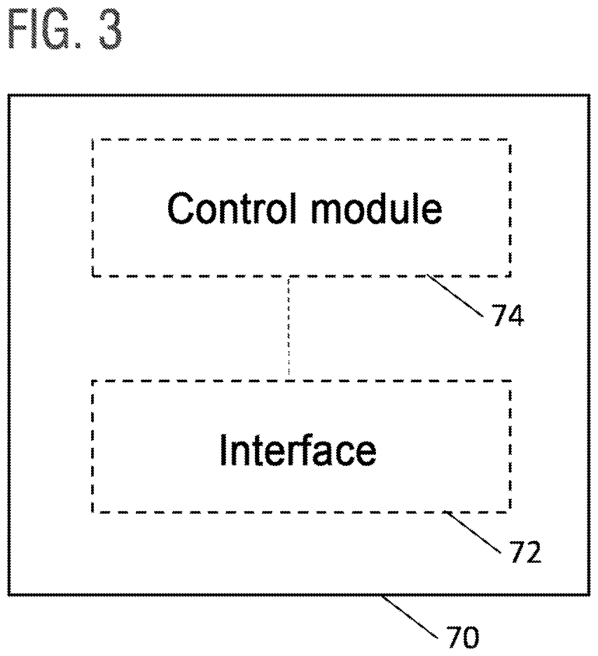

Further details and aspects are mentioned in connection with the exemplary embodiments described below and/or above. The exemplary embodiment shown in FIG. 2 can have one or more optional additional features corresponding to one or more aspects mentioned in the context of the proposed concept or one or more exemplary embodiments described above (for example FIG. 1) and/or below (for example FIGS. 3-7).

FIG. 3 shows a block diagram of an exemplary embodiment of a user terminal 70. The user terminal 70 for identification of an owner comprises an interface 72 designed to communicate with a server (for example the server as described above, for example with reference to FIG. 2) and a hardware token (for example the device as described above, for example with reference to FIG. 1) and a control unit 74 designed to control the interface 72. Furthermore, the control module 74 is designed to send a request for an intended identification to the server and to receive information about an intended identification from the server. Furthermore, the control module 74 is designed to send the information about the intended identification to the hardware token and to receive signed information based on the information about the intended identification from the hardware token. The signed information can be used for identification of the owner. Furthermore, the control module 74 is designed to send the signed information to the server and receive information for identification of the owner from the server. The user terminal 70 can therefore enable a user to identify themself as the owner. To do this, the user needs only the hardware token, a communicative connection to the hardware token, for example via near-field communication, and a communicative connection to a server, for example via a mobile data connection. This allows improved identification as the owner for a user. In addition, costs for a plurality of vehicle keys can be reduced.

In an exemplary embodiment, the control module 74 can also be designed to carry out a verification of the signed information based on the intended identification. This enables the user terminal 70 to check, for example, whether a correct hardware token has been used for an intended identification. For example, a user of the user terminal 70 can have a plurality of hardware tokens for a plurality of vehicles. The signed information received can then be compared for consistency with the information about an intended identification. This allows the user to be given feedback, for example, if they have used an incorrect hardware token.

In an exemplary embodiment, the control module 74 may also be designed to receive a digital signature from the server. The digital signature can enable unique identification of the owner. This enables a user of the user terminal to prove ownership, for example, the digital signature can be a digital vehicle registration document.

In an exemplary embodiment, the control module 74 may also be designed to perform a pairing, in particular an owner pairing, with a vehicle based on the information for identification of the owner. In particular, the owner pairing can train a master user terminal 70 to provide access to the vehicle, so that the master user terminal 70 can, for example, start, open, close, etc. the vehicle. After the owner pairing, the master user terminal 70, for example, can be designed to assign friend keys for log in to the vehicle for other user terminals.

As shown in FIG. 3, the one or more interfaces 72 are coupled to the respective control module 74 of the user terminal 70. In examples, the device 74 can be implemented by one or more processing units, one or more processing devices, any means of processing, such as a processor, a computer or a programmable hardware component that can be operated with appropriately adapted software. Likewise, the described functions of the control module 74 can also be implemented in software that is then executed on one or more programmable hardware components. Such hardware components may include a multi-purpose processor, a digital signal processor (DSP), a microcontroller, etc. The control module 74 may be able to control the one or more interfaces 72 so that any data transmission carried out through the one or more interfaces 72 and/or any interaction in which the one or more interfaces 72 may be involved can be controlled by the control module 74.

In an embodiment, the user terminal 70 may contain a memory and at least one control module 74 that is functionally coupled to the memory and configured in such a way that it will carry out the method described below.

In examples, the one or more interfaces 72 may correspond to any means of obtaining, receiving, transmitting, or providing analog or digital signals or information, such as any port, contact, pin, register, input port, output port, conductor, track, etc., that allows the provision or receipt of a signal or information. The one or more interfaces 72 can be wireless or wired and can be configured to be able to communicate with other internal or external components, for example to send or receive signals or information.

The user terminal 70 can generally be a device that is capable of communicating wirelessly. In particular, the user terminal 70 can be a mobile user terminal, for example a user terminal that is suitable to be carried by a user. The user terminal can be, for example, a user terminal (UT) or user equipment (UE) in the sense of the respective communication standards used for mobile communication. For example, the UE can be a mobile phone, such as a smartphone, or another type of mobile communication device, such as a smartwatch, laptop, tablet computer, autonomous augmented reality glasses, etc.

In at least some exemplary embodiments, the user terminal 70 can be contained by a vehicle. For example, the vehicle can correspond to a land vehicle, a watercraft, an aircraft, a rail vehicle, a road vehicle, a car, a bus, a motorcycle, an off-road vehicle, a motor vehicle, or a truck.

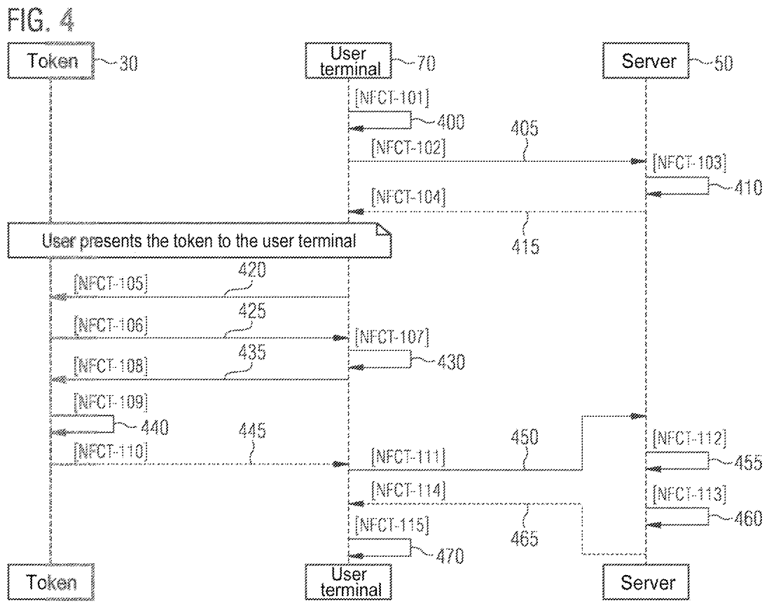

Further details and aspects are mentioned in connection with the exemplary embodiments described below and/or above. The exemplary embodiment shown in FIG. 3 may have one or more optional additional features corresponding to one or more aspects mentioned in the context of the proposed concept or one or more exemplary embodiments described above (for example FIGS. 1-2) and/or below (for example FIGS. 4-7).

FIG. 4 shows a flowchart of an example of a method 400. A user can start 400 an identification as owner by means of their user terminal 70. In particular, the user, for example a vehicle owner, can start a process to set up a digital key for a vehicle. For example, the user can start an application on the user terminal 70, in particular an application that is associated with a manufacturer of a vehicle. The user terminal 70, for example the application, can then send 405 a request for information about an intended identification to the server 50. For example, the server 50 can be a backend for a plurality of vehicles.

The server 50 can generate 410 information about an intended identification. Optionally, the server 30 may provide the generated information about an intended identification with a period of validity. In particular, the server may contain information (for example, stored on a memory medium) as to which hardware token belongs to which associated device. The server 50 can then send 415 the information about an intended identification to the user terminal 70. Optionally, the server 50 can also send information about a hardware token belonging to the information about the intended information, i.e. token information, 30.

The user can hold the hardware token 30 at a near-field communication interface of their user terminal 70. The user terminal 70 can then establish a connection to the hardware token 30 and send 435 the information about the intended identification to the hardware token 30, for example by means of the application. The hardware token 30 can then generate 440 signed information and send 445 it to the user terminal 70, for example using near-field communication. The signed information can be created in particular by means of asymmetric cryptography.

Optionally, if the user terminal 70 has received token information, a check of a used hardware token 30 can take place. For example, the user terminal 70 can first send 420 a request for token information to the hardware token 30. The hardware token 30 can then send 425 a response to the request to the user terminal 70. The user terminal 70 can then check 430 the token information and only when a match is detected, i.e. the user has used a hardware token that matches the information of the intended identification, can the information about the intended information be sent 435.

The user terminal 70 can send 450 the signed information to the server 50. The server 50 can verify 460 the signed information. Optionally, the server 50 can reset 455 a validity period, for example can stop a timer for a validity period. When the signed information is verified, the server 50 can send 465 information for identification of the owner to the user terminal. Based on the information for identification of the owner, the user terminal 70 can then start 470 an owner pairing with the vehicle belonging to the hardware token 30.

Alternatively, the hardware token cannot be verified by an application of the user terminal 70, but by a standard in the operating system, for example. In particular, communication between the user terminal 70 and the hardware token 30 can also take place independently of an application of the user terminal 70. For example, the user terminal 70 can communicate with the hardware token in accordance with a digital key of the Car Connectivity Consortium (CCC) standard. In particular, the hardware token can be a digital key in accordance with the CCC standard. For example, the standard CCC-TS-101 Digital Key Technical Specification Release 3, version 1.0.0 can be used to communicate between the user terminal and the hardware token.

For example, chapter 6.3.2 on page 80 describes the introduction to owner pairing (master device pairing). (“To start owner pairing mode (Step 3 of FIG. 6-2), the device receives the password, either through user input, a URL (see Section 6.3.7), or through an API directly from the Vehicle OEM app, if installed.”). In particular, Chapter 6.3.2 can be adapted to implement a hardware token that can be used to prove ownership. In particular, a protocol that can be used for communication between the user terminal and the hardware token can be defined as a separate transaction. For example, such a communication can be recorded comparably to the Chapters “7 Standard Transaction/8 fast Transaction/Check Presence Transaction”. Individual commands for such a transaction can be included in Chapter “15.3.2 Commands”.

Alternatively, the user terminal 70 can be permanently arranged in the vehicle belonging to the hardware token. For example, a vehicle may contain a near-field communication reader that serves as a user terminal 70. A hardware token 30 can then be read particularly easily by the associated vehicle.

Optionally, or alternatively, the hardware token 30 cannot directly act as a release of an owner pairing. The hardware token 30 can be used, for example, to generate information in an application of the user terminal 70, for example the digital signature, for example a vehicle registration document. The digital signature can then be used in a further optional step to generate the information for an identification, i.e. in particular for carrying out an owner pairing.

A specific design of the method 400 is shown below. The method 400 can be carried out in particular by means of an application on the user terminal 70. In particular, the application can an enable owner pairing (tag: [App-NFCT-123]). In particular, the server 50 can display all digital keys that are linked to a backend of a plurality of vehicles (tag: [BE-NFCT-123]). The hardware token 30 can be, in particular, as specified in [HWT-NFCT-100] (tag: [HWT-NFCT-123]).

The following documents are referred to below: [CCC-R3] Digital Key Technical Specification Release 3 vl.0.0 and [FIPS-186] PIPS PUB 186-4—Digital Signature Standard—July 2013.

Specification for [HWT-NFCT-100]:

The hardware token 30 can have the following properties:
TokenKeypair
ECC key pair, generated according to [FIPS-186] with ‘ECC NIST P-256’
Token.SK (32 Bytes) & Token.PK (64 Bytes)
TokenInformation/TokenIdentifier (20 byte)=SHA-1 hash of the value of the BIT STRING subjectPublicKey (=Token.PK).
   For each hardware token, the server, especially a backend, stores a 1 to 1 association with the associated vehicle. (Binding process spec in progress)
   The hardware token 30 supports the following NFC commands, which are detailed further below:
      SELECT command/response
      SIGN command/response

[HWT-NFCT-101]: If the hardware token 30 for the associated vehicle is not available, the application should cancel a method 400. If the hardware token 30 is available, the application can inform the user that the user must connect the hardware token 30 to the user terminal in order to start an owner pairing. The method 400 can then be continued with [APP-NFCT-102]. It is assumed that the application contains information about the support of a hardware token by a vehicle.

[APP-NFCT-102]: The application requests information about the intended identification from the server 50. For example, the command for this can be:
requestTokenChallenge (vehicleIdentifier)
info: interface needs to be specified in detail.

[BE-NFCT-103]: The server 50 can perform a check as to whether the selected vehicle is associated with or supports a hardware token. In particular, the server 50 may receive information about which user terminal 70 the request comes from and/or for which vehicle the request is made. If the requested vehicle is not associated with a hardware token, a the server 50 may send a “HardwareTokenNotSupported” error message to the user terminal. Otherwise, the server 50 can determine token information (also known as a TokenIdentifier) that is associated with the vehicle. Furthermore, the server 50 can generate random information about an intended identification, for example with a length of 32 bytes. Optionally, the server 50 can define a validity period and/or start a timer, such as a TokenChallengeTimer=10 s, which is associated with the information about an intended identification (also known as a TokenChallenge).

[BE-NFCT-104]: the server 50 responds to the requestTokenChallenge with the payload:
TokenChallenge of [BE-NFCT-103]
TokenIdentifier of [BE-NFCT-103] [APP-NFCT-105]: The application can send the following APDU to the hardware token 30 via an NFC interface:

TABLE
SELECT Command - APDU Structure:

| CLA | INS | Pl | P2 | Le | Data | Le |
|---|---|---|---|---|---|---|
| 00 h | A4h | 04 h | 00 h | var. | tbd [HWT-AID] | 00 h |

[HWT-NFCT-106]: The hardware token can respond with the following APDU:

TABLE
SELECT Response - APDU Structure:

| Data | SW |
|---|---|
| [table: SELECT response - payload TLV] | 90 00h |

TABLE
SELECT Response - payload TLV:

| Day | Length | Value | Description |
|---|---|---|---|
| 41h | 01H (LD) | 01h | version |
| 5Dh | 14h (20d) | var. | [HWT.TokenIdentifier] |

[NFCT-107]: The application can receive the BE.TokenIdentifier in [BE-NFCT-104] with the HWT.TokenIdentifier [HWT-NFCT-106]. If the BE.TokenIdentifier !=HWT.TokenIdentifier then the application should inform the user that the correct hardware token belonging to the associated vehicle has not been presented/connected. The method 400 can then be ended. Otherwise, if the correct hardware token has been presented/connected, [APP-NFCT-108] can be executed.

[APP-NFCT-108]: The application can send the following APDU via an NFC interface of the user terminal 70 and the hardware token 30 (especially in accordance with [CCC-R3]—Chapter 15.3.2.23):

TABLE
SIGN Command - APDU Structure:

| CLA | INS | Pl | P2 | Lc | Data | Le |
|---|---|---|---|---|---|---|
| 80 h | 30 h | 01 h | 00 h | Var. | [Table: Sign | 00 h |
| | | (UA not | | | Command - payload | |
| | | needed) | | | TLV] | |

TABLE
SIGN command - payload TLV:

| Day | Length | Value | Description |
|---|---|---|---|
| 50h | 14h (20d) | [TokenIdentifier] | BE.TokenIdentifier received |
| | | | in [BE-NFCT-104] |
| 58h | 20h (32d) | [TokenChallenge] | BE.TokenChallenge received |
| | | | in [BE-NFCT-104] |

[HWT-NFCT-109]: The hardware token can generate the signed information, also referred to as the TokenSignature, as follows:
Algorithm: ECDSA with SHA-256 with ‘ECC NIST P-256’ according to [FIPS-186] Data to be signed: [Table: SIGN Data fields], Secret Key: Token.SK as defined in [HWT-NFCT-100] Output: TokenSignature−Length: 64 Bytes

TABLE
SIGN Data fields

| Day | Length | Value | Description |
|---|---|---|---|
| 41h | 01h (LD) | 01h | version |
| 92h | 08h (8d) | var. | [random] - generated by the |
| | | | hardware token |
| 5Dh | 14h (20d) | var. | [HWT.Token Identifier]. |
| 58h | 20h (32d) | var. | [TokenChallenge] |
| 93h | 04h (4d) | FC6F4C17h | usage - UA not performed |

[HWT-NFCT-110]: The hardware token can respond with the following APDU:

TABLE
SIGN Response - APDU Structure:

| Data | SW |
|---|---|
| [table: SIGN response - payload TLV] | 90 00h |

TABLE
SIGN Response - payload TLV:

| Day | Length | Value | Description |
|---|---|---|---|
| 41h | 01h (1d) | 01h | version |
| 92h | 08h (8d) | var. | [random] - generated in [HWT-NFCT-109] |
| 5Dh | 14h (20d) | var. | [HWT.Token Identifier] |
| 9Eh | 40h (64d) | var. | [TokenSignature] generated in |
| | | | [HWT-NFCT-109] |

[APP-NFCT-111]: The application can then request an owner pairing password from the server 50, in particular by sending the TokenSignature as follows:
getPairingPassword (vehicleIdentifier, TokenSignature) Information: Interface to be for the extended TokenSignature.

[BE-NFCT-112]: When a getPairingPassword for a vehicle from the user terminal 70 is received by the server 50, which requires a TokenSignature, the server 50 can verify whether the TokenChallengeTimer ([BE-NFCT-103]) has expired. If the TokenChallengeTimer has expired, an error message may be sent to the user terminal 70 from the server 50, for example, “TokenChallengeTimer expired”. The method 400 can then be ended. If the TokenChallengeTimer has not expired, the method 400 can be continued with [BE-NFCT-113].

[BE-NFCT-113]: The server can verify the validity of the TokenSignature as follows:
Hash: SHA-256 using [Table: SIGN Data fields] Public Key: Token.PK as defined in [HWT NFCT-100]. An algorithm can be: verify ECDSA with ‘ECC NIST P-256’ as in [FIPS-186]; IF signature==invalid: output an error message, for example “TokenSignature invalid” and end the method 400. Otherwise, the method 400 can be continued with [BE-NFCT-114].

[BE-NFCT-114]: The server 50 can send the information for the identification (for example an owner pairing password) to the user terminal. In particular, in response to the request for the owner pairing password.

[BE-NFCT-115]: The application can start an owner pairing, in particular based on a call to an operating software of the user terminal. In particular, the application can use the owner pairing password for this purpose.

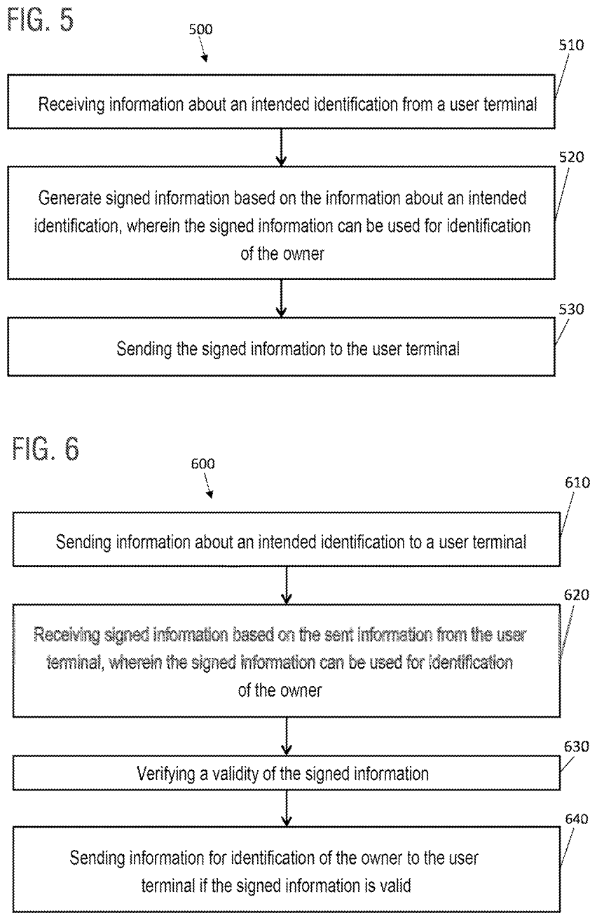

Further details and aspects are mentioned in connection with the exemplary embodiments described below and/or above. The exemplary embodiment shown in FIG. 4 may have one or more optional additional features corresponding to one or more aspects mentioned in the context of the proposed concept or one or more exemplary embodiments described above (for example FIGS. 1-3) and/or below (for example FIGS. 5-7).

FIG. 5 shows a schematic representation of an example of a method 500. The method 500 for identification of an owner includes receiving 510 information about an intended identification from a user terminal and generating 520 information signed based on the information about an intended identification. The signed information can be used for identification of the owner. The method 500 also includes sending 530 the signed information to the user terminal. The procedure may be carried out, for example, by a device as described above, in particular with reference to FIG. 1.

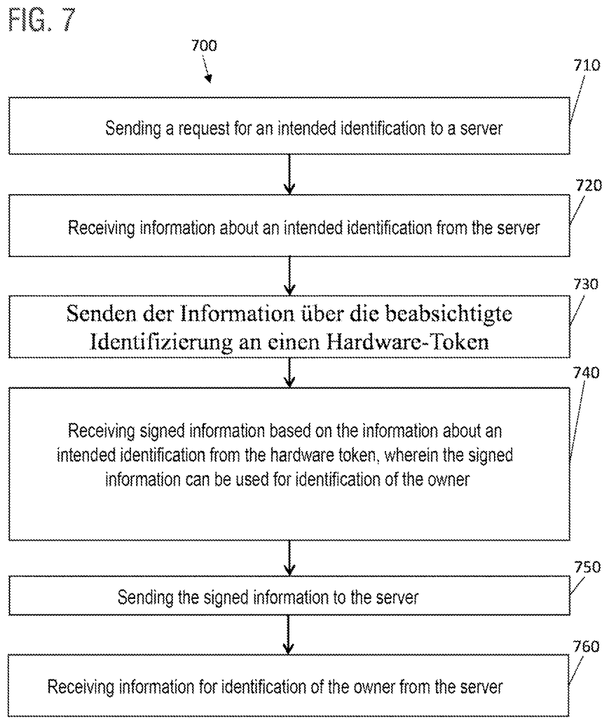

Further details and aspects are mentioned in connection with the exemplary embodiments described below and/or above. The exemplary embodiment shown in FIG. 5 can have one or more optional additional features corresponding to one or more aspects mentioned in the context of the proposed concept or one or more exemplary embodiments described above (for example FIGS. 1-4) and/or below (for example FIGS. 6-7).

FIG. 6 shows a schematic representation of an example of a further method 600. The method 600 for a server includes sending 610 information about an intended identification to a user terminal and receiving 620 signed information from the user terminal based on the information sent. The signed information can be used for identification of the owner. Furthermore, the method includes verifying 630 the validity of the signed information and sending 640 information for identification of the owner to the user terminal if the signed information is valid. In particular, the method 600 can be carried out by a server as described above, for example with reference to FIG. 2.

Further details and aspects are mentioned in connection with the exemplary embodiments described below and/or above. The exemplary embodiment shown in FIG. 6 may have one or more optional additional features that correspond to one or more aspects mentioned in the context of the proposed concept or one or more exemplary embodiments described above (for example FIGS. 1-5) and/or below (for example FIG. 7).

FIG. 7 shows a schematic representation of an example of another method 700. The method 700 for a user terminal includes sending 710 a request for an intended identification to a server and receiving 720 information about an intended identification from the server. Further, the method 700 includes sending 730 the information about the intended identification to a hardware token and receiving 740 signed information based on the information about an intended identification from the hardware token. The signed information can be used for identification of the owner. Furthermore, the method 700 includes sending 750 the signed information to the server and receiving information for identification of the owner from the server. In particular, the method 700 can be carried out by a user terminal as described above, for example with reference to FIG. 3.

Further details and aspects are mentioned in connection with the exemplary embodiments described above. The exemplary embodiment shown in FIG. 7 may have one or more optional additional features corresponding to one or more aspects that are mentioned in connection with the proposed concept or with one or more exemplary embodiments described above (for example FIGS. 1-6).

### LIST OF REFERENCE SIGNS

30 Device
32 Interface
34 Control module
50 Server
52 Interface
54 Control module
70 User terminal
72 Interface
74 Control module
500 Method for identification of an owner
510 Receiving information
520 Generating signed information
530 Sending the signed information
600 Method for a server
610 Sending information
620 Receiving signed information
630 Verifying a validity
640 Sending information
700 Method for a user terminal
710 Sending a request
720 Receiving information
730 Sending the information
740 Receiving signed information
750 Sending the signed information
760 Receiving information

1.-15. (canceled)

16. A device for identification of an owner, comprising:
an interface configured to communicate with a user terminal; and
a control module configured to control the interface, the control module further configured to,
receive information about an intended identification of the user terminal;
generate signed information based on the information about an intended identification, wherein the signed information can be used for identification of the owner; and
send the signed information to the user terminal.

17. The device as claimed in claim 16, wherein the device and the user terminal are configured to communicate using near-field communication.

18. The device as claimed in claim 16, wherein
the signed information includes time information corresponding to a generation of the signed information.

19. A vehicle with a user terminal as claimed in claim 16.

20. A server for identification of an owner, comprising:
an interface configured to communicate with a user terminal; and
a control module configured to control the interface, and further configured to,
send information about an intended identification to the user terminal;
receive signed information based on the sent information from the user terminal, wherein the signed information can be used for identification of the owner;
verify a validity of the signed information; and
responsive to the verification of the validity of the signed information, send information for identification of the owner to the user terminal.

21. The server as claimed in claim 20, wherein the information about the intended identification includes a period of validity of the intended identification.

22. The server as claimed in claim 21, wherein the control module is further configured to receive a request for an intended identification from a user terminal.

23. The server as claimed in claim 20, wherein the control module is further configured to receive a request for an intended identification from a user terminal.

24. The server as claimed in claim 23, wherein the control module is further configured to:
generate a digital signature based on the signed information, wherein the digital signature enables unique identification of the owner; and
send the digital signature to the user terminal.

25. The server as claimed in claim 20, wherein the control module is further configured to:
generate a digital signature based on the signed information, wherein the digital signature enables unique identification of the owner; and
send the digital signature to the user terminal.

26. A user terminal for identification of an owner, comprising:
an interface configured to communicate with a server and a hardware token; and
a control module configured to control the interface, and further configured to:
send a request to the server for an intended identification;
receive information about the intended identification from the server;
send the information about the intended identification to the hardware token;
receive signed information based on the information about the intended identification from the hardware token, wherein the signed information can be used for identification of the owner;
send the signed information to the server; and
receive information for identification of the owner from the server.

27. The user terminal as claimed in claim 26, wherein the control module is further configured to perform a verification of the signed information based on the intended identification.

28. The user terminal as claimed in claim 26, wherein the control module is further configured to:
receive a digital signature from the server, wherein the digital signature enables a unique identification of the owner.

29. A vehicle with a device as claimed in claim 26.

30. A method for identification of an owner, comprising:
receiving information about an intended identification from a user terminal;
generating signed information based on the information about the intended identification, wherein the signed information can be used for identification of the owner; and
sending the signed information to the user terminal.

31. A method for a server for identification of an owner, comprising:
sending information about an intended identification to a user terminal;
receiving signed information based on the sent information from the user terminal, wherein the signed information can be used for identification of the owner;
verifying a validity of the signed information; and
sending information for identification of the owner to the user terminal responsive to verifying the validity of the signed information.

32. A method for a user terminal for identification of an owner, comprising:
sending a request for an intended identification to a server;
receiving information about the intended identification from the server;
sending the information about the intended identification to a hardware token;
receiving signed information based on the information about the intended identification from the hardware token, wherein the signed information can be used for identification of the owner;
sending the signed information to the server; and
receiving information for identification of the owner from the server.

33. A nontransitory computer-readable medium containing a computer program that, when executed on a computer, a processor or a programmable hardware component, performs the method of claim 32.
